(19) United States
(12) Patent Application Publication
(10) Pub. No.: US 2010/0241965 A1
(43) Pub. Date: Sep. 23, 2010

(54) MOBILE TERMINAL APPARATUS

(75) Inventor: Kenji ISHII, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/721,671

(22) Filed: Mar. 11, 2010

(30) Foreign Application Priority Data
Mar. 19, 2009 (JP) 2009-067309

(51) Int. Cl. G06F 3/048; G06F 15/16

(52) U.S. Cl. 715/739; 715/760; 715/752

(57) ABSTRACT

An apparatus includes: a display; a memory for storing site address used by first application and contents information including title and associated contents data used by second application independently from the first application; and a processor for executing a process including: controlling operation of the first and second applications independently; displaying a bookmark including the address on the display, accessing one site when the user selects address corresponding to the site displayed on the bookmark, and displaying contents retrieved from the one site by the first application; and enabling any of the title to be added to the bookmark by a user operation, extracting, when the title added to the bookmark is displayed and selected by the user, a portion of the contents data selected by the user, and displaying the extracted portion of the content data.

### CROSS-REFERENCE TO RELATED APPLICATION

This application is based upon and claims the benefit of priority of the prior Japanese Patent Application No. 2009-067309, filed on Mar. 19, 2009 the entire contents of which are incorporated herein by reference.

### FIELD

The embodiment discussed herein is related to a mobile terminal apparatus.

### BACKGROUND

In recent years, mobile terminal apparatuses (moving body terminals) such as mobile phones having a web browser that can access a world wide web (WWW) site in the same way as a computer such as a desktop personal computer (PC) and a laptop PC browses the web site have become widely available. According to the above-described mobile terminal, a user specifies (including inputting and/or selecting) a uniform resource locator (URL) which is the address and/or the identifier of the web site through the web browser so that the user can view the content data of the web page corresponding to the specified URL.

The web browser includes the function of arbitrarily registering information about the URL of the web site corresponding to a web page which is currently viewed by the user. The user registers URL information items in the mobile terminal through the use of the registering function so as to display the list of the registered URL information items and select a URL information item in the displayed list by performing a pointing operation. As a result, the user can easily and directly view a web page indicated by the selected URL information item.

For example, the term “bookmark” derived from the term “bookmarker” and/or the term “favorite” denotes the function of registering and managing the URL of a web site as the URL information. Since no particular limitation is required in this specification, the term “bookmark” will be described as the URL information.

A known mobile terminal having a bookmark function used to manage the URL of a web site, particularly, a mobile phone can only manage bookmark data of a web browser through a simple hierarchical folder configuration. Namely, it is difficult to directly use URL information included in different content data (e.g., mail data) stored in the mobile terminal through the web browser and/or the bookmark function.

When using the mobile terminal, the URL information may not only be the bookmark data. Namely, URLs are also included in text memo data, data of the main body of an electronic mail, address book data, and so forth. However, for starting the web browser based on each of the above-described URLs that are different from the URL shown as the bookmark data, information about the URLs is registered as the bookmark data collectively and/or automatically. Otherwise, each of application programs handling the individual URLs may be first started. After that, an appropriate URL is selected and the web browser is started.

At least one of Japanese Laid-open Patent Publication No. 11-242677, Japanese Laid-open Patent Publication No. 2007-104390, and Japanese Patent No. 3000983 (Japanese Laid-open Patent Publication No. 11-161584) discloses the technology of registering data of the URL of a web site in association with personal information (personal information manager (PIM) data) including information about a schedule, an address book, a memo, and so forth while the web site is being displayed through a web browser. According to the above-described technology, activation of the web browser is selected through a PIM application program which is a separate application program so that the web site is displayed based on the URL data registered in association with the personal information. A system of using the PIM data through the bookmark function is not disclosed in any of the above-described patent documents.

Further, at least one of the above-described patent documents discloses the technology of collectively registering URL information items, which are registered in a phone book, as the bookmark data in a mobile phone terminal including a mobile phone, a personal handyphone system (PHS), and so forth that are small in size and provided with a phone function. Still further, at least one of the above-described patent documents discloses the technology of automatically registering information about a URL included in the main body of an electronic mail as the bookmark data. Each of the above-described technologies suggests copying URL information included in predetermined data to the bookmark data collectively and/or automatically. Accordingly, an equivalent URL information item is stored in two areas and therefore additional memories for storing the URL information item is provided. Further, undesired URL information is also registered as the bookmark data.

When the URL information items are registered as the bookmark data collectively and/or automatically, the above-described problems occur. However, if the URL information items are not registered collectively and/or automatically, a user has to start a different and related application program even though the web browser has already been executed.

### SUMMARY

According to an aspect of the invention, an apparatus includes: a display; a memory for storing site address used by first application and contents information including title and associated contents data used by second application independently from the first application; and a processor for executing a process including: controlling operation of the first and second applications independently; displaying a bookmark including the address on the display, accessing one site when the user selects address corresponding to the site displayed on the bookmark, and displaying contents retrieved from the one site by the first application; and enabling any of the title to be added to the bookmark by a user operation, extracting, when the title added to the bookmark is displayed and selected by the user, a portion of the contents data selected by the user, and displaying the extracted portion of the content data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a block diagram illustrating an exemplary functional configuration of a mobile terminal according to an embodiment.

FIG. 2 is a flowchart illustrating bookmark folder list display processing.

FIG. 3A, FIG. 3B, FIG. 3C, FIG. 3D, FIG. 3E, and FIG. 3F illustrate the bookmark folder list display processing.

FIG. 4 is a flowchart illustrating mail-adaptable display processing.

FIG. 5A, FIG. 5B, FIG. 5C, FIG. 5D, and FIG. 5E illustrate the mail-adaptable display processing.

FIG. 6A and FIG. 6B illustrate an exemplary configuration of a mail database (DB).

FIG. 7A, FIG. 7B, and FIG. 7C illustrate processing performed to store data in the mail DB.

FIG. 8 is a flowchart illustrating address book-adaptable display processing.

FIG. 9A, FIG. 9B, FIG. 9C, and FIG. 9D illustrate the address book-adaptable display processing.

FIG. 10A and FIG. 10B illustrate an exemplary configuration of an address book DB.

FIG. 11 is a flowchart illustrating text memo-adaptable display processing.

FIG. 12A and FIG. 12B illustrate an exemplary configuration of a text memo DB.

FIG. 13 is a flowchart illustrating schedule-adaptable display processing.

FIG. 14A and FIG. 14B illustrate an exemplary configuration of a schedule DB.

FIG. 15A is a flowchart illustrating a URL copying function.

FIG. 15B is another flowchart illustrating the URL copying function.

FIG. 15C is another flowchart illustrating the URL copying function.

FIG. 16A, FIG. 16B, FIG. 16C, FIG. 16D, FIG. 16E, FIG. 16F, and FIG. 16G illustrate the URL copying function.

### DESCRIPTION OF EMBODIMENT

Hereinafter, preferred embodiments will be described in detail with reference to drawings. However, it should be noted that the present invention may be performed in many different ways without being limited to the above-described embodiments.

### Configuration of Mobile Terminal

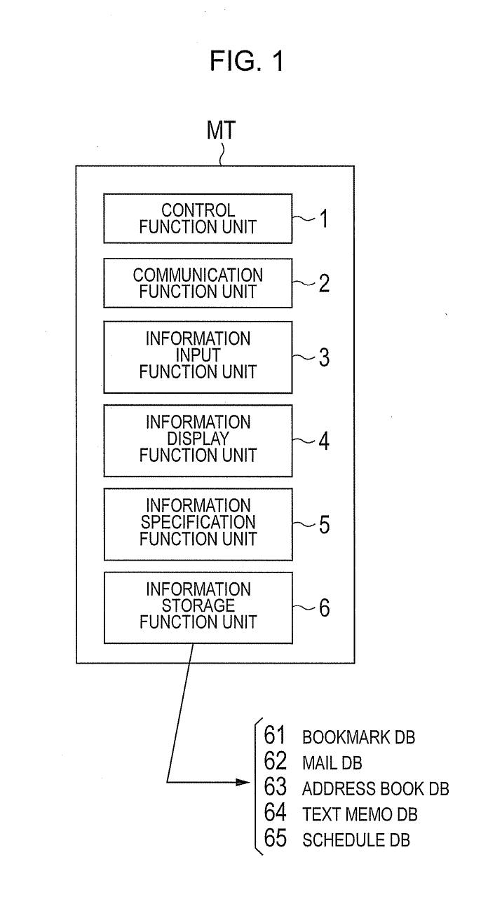

FIG. 1 illustrates an exemplary configuration of a mobile terminal (moving body terminal) MT including a bookmark function according to an embodiment.

According to FIG. 1, a mobile terminal MT used by a user may be a mobile phone terminal such as a mobile phone and a PHS, and/or a mobile information terminal including a personal digital assistant (PDA) or the like as long as the mobile terminal MT includes a control function unit 1, a communication function unit 2, an information input function unit 3, an information display function unit 4, an information specification function unit 5, an information storing function unit 6, and so forth. Namely, the mobile phone terminal and the mobile information terminal may be used singly or in combination as the mobile terminal MT.

According to an exemplary hardware configuration of the mobile terminal MT, the following components are provided in the mobile terminal MT. Namely, the control function unit 1 includes a central processing unit (CPU) functioning as a processor, a random access memory (RAM) functioning as a work memory, and a read only memory (ROM) storing various application programs including a web browser or the like. The communication function unit 2 includes a radio communication unit, the information input function unit 3 includes a ten-key numeric pad and various function buttons (keys), the information display function unit 4 includes a display, and the information specification function unit 5 includes a pointing unit and a cursor control unit. Further, the information storing function unit 6 includes a nonvolatile memory storing various types of databases 61, 62, 63, 64, and 65. The above-described hardware configurations, which can be easily understood and executed by a person skilled in the art, are not illustrated.

The mobile terminal MT can operate application functions independently. The mobile terminal MT is capable of connecting to a plurality of sites via a network.

The display device displays contents information by the application functions. At least one of the RAM and the ROM store address information of any of the sites to be used by the application function and contents information including title information and associated contents data to be used by the application function. The CPU execute a process including: controlling operation of the application functions independently; displaying a bookmark list including the address information on the display device in response to a user's operation, accessing one of the sites when address information corresponding to the one of the sites displayed on the bookmark list is selected by the user, and displaying contents information retrieved from the one of the sites by the application function; and enabling any of the title information to be added to the bookmark list by a user operation, extracting, when the title information added to the bookmark list is displayed and selected by the user, any portion of the contents data included in the contents information corresponding to the title information selected by the user, and displaying the extracted portion of the content data. The portion may be address information included in the contents data.

For logically achieving a URL information management function which will be described later, a web browser and a URL information management program are installed on the ROM of the control function unit 1 of the mobile terminal MT as application programs. Consequently, the CPU expands the above-described application programs into the RAM and executes the application programs upon receiving a request issued from the user.

### URL Information Management Function

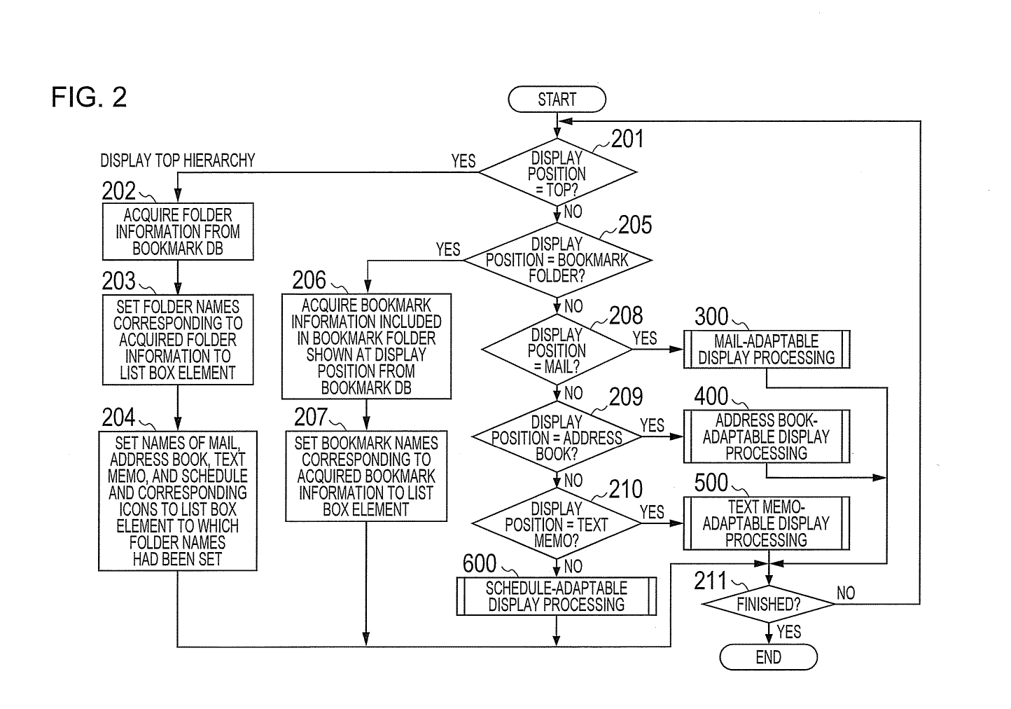

Next, a URL information management function of the mobile terminal MT according to the above-described embodiment illustrated in FIG. 1 will be described with reference to FIGS. 2 to 16.

In the mobile terminal MT used by the user, the URL information management program executes the URL information management function in conjunction with the control function unit 1, the communication function unit 2, the information input function unit 3, the information display function unit 4, the information specification function unit 5, the information storage function unit 6, and so forth.

(Bookmark Folder List Display Processing)

First, upon receiving a bookmark display request transmitted from the user (specification operation) via a menu screen (not illustrated), the CPU of the control function unit 1 of the mobile terminal MT expands the URL information management program installed on the ROM as the application program and the web browser into the RAM, and executes bookmark folder list display processing by performing the following steps.

When the display position of the bookmark list (display object state) is the top hierarchy (the top of a hierarchy) (201 illustrated in FIG. 2), the URL information management program (or simply referred to as a management program) acquires folder information from the bookmark database (DB) 61 provided in the information storage function unit 6 (202) so as to display a bookmark folder list. Then, the management program sets the folder names corresponding to the acquired folder information to a list box element in sequence (203). Further, the management program sets the names of an electronic mail, an address book, a text memo, and a schedule, and the corresponding icons to the list box element to which the folder names had already been set (204), and determines whether or not the processing may be finished (211). The processing is continued until the user operates a finish button provided on the mobile terminal MT.

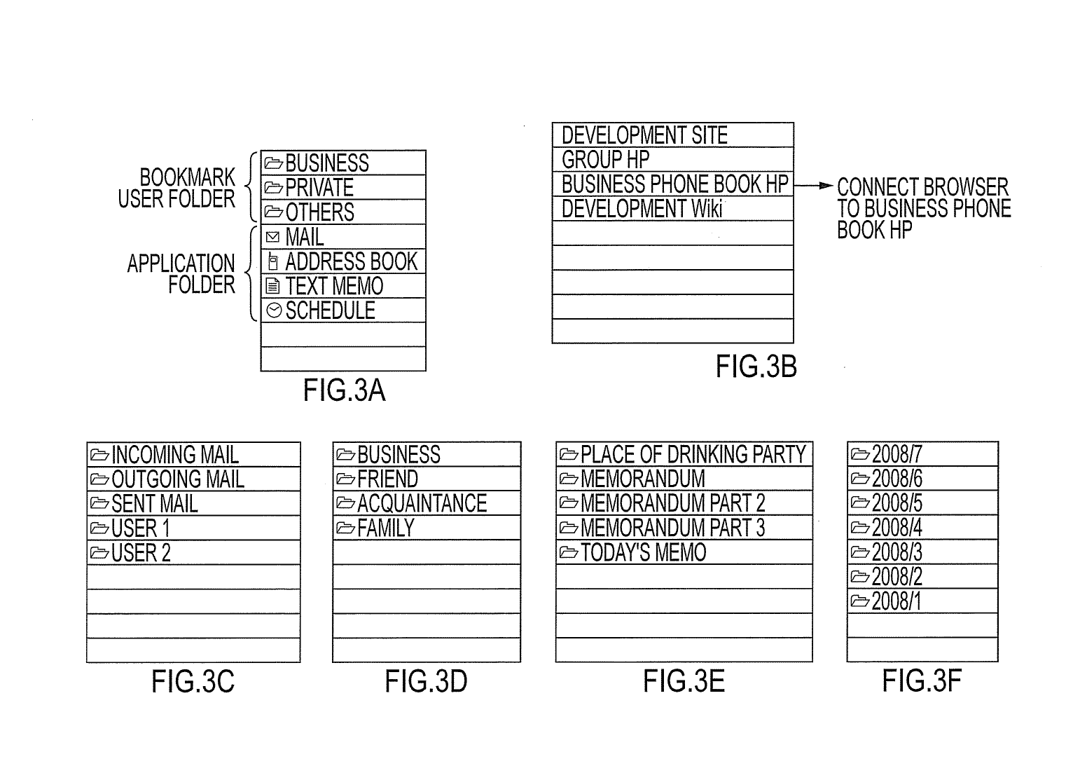

As a result of the above-described processing performed to set the data to the list box element, the bookmark folder list is displayed as illustrated in FIG. 3A. Here, each of folders “business”, “private”, and “others” is generated by the user and provided for a bookmark which is inherently managed through the bookmark function of the web browser. Further, each of folders “mail”, “address book”, “text memo”, and “schedule” is an application folder which is inherently provided for an application program such as a mail application program. Each of the above-described application folders is a virtual bookmark folder. The management program manages each of the bookmark folders generated by the user and the virtual bookmark folders as a bookmark folder.

If the management program does not determine to finish the processing at step 211, the management program returns to make the determination corresponding to step 201. Further, when the display object state of the bookmark list does not correspond to the top hierarchy, namely, when the state where the bookmark folders illustrated in FIG. 3A had already been displayed (the state may be simply referred to as the display state) is achieved (205), bookmark folder information included in a bookmark folder illustrated at the display position is acquired from the bookmark DB 61 (206). Further, the bookmark names corresponding to the acquired bookmark folder information are set to the list box element (207), and it is determined whether or not the processing may be finished (211).

For example, when the bookmark folders of the top hierarchy illustrated in FIG. 3A had already been displayed and the folder “business” is specified (selected) based on an operation performed by the user, the management program acquires bookmark folder information included in the folder “business” which is the bookmark folder illustrated at the display position from the bookmark DB 61. Then, the management program sets the bookmark names corresponding to the acquired bookmark folder information to the list box element, where the bookmark names are illustrated as “development site”, “business phone book HP”, and so forth illustrated in FIG. 3B. Here, when the bookmark name “business phone book HP” set to the list box element is specified based on an operation performed by the user, a web browser running in conjunction with the management program is started and access to the web site corresponding to URL data included in the bookmark folder information is made.

If the management program does not determine to finish the processing at step 211, the management program returns to make the determination corresponding to step 201. Then, when the display position of the bookmark list, that is, the display object state does not correspond to the top hierarchy but a single electronic mail of a lower hierarchy (208), the management program performs mail-adaptable display processing (300). Further, when the display position corresponds to any different folder of the lower hierarchy, display processing adaptable to the different folder is performed. Namely, when the display position is the address book (209), the management program performs address book-adaptable display processing (400). Further, when the display position is the text memo (210), the management program performs text memo-adaptable display processing (500). Still further, when the display position is not any one of the mail, the address book, and the text memo, the management program performs schedule-adaptable display processing (600).

In the state where the bookmark folders of the top hierarchy illustrated in FIG. 3A are displayed and each of the folders “mail”, “address book”, “text memo”, and/or “schedule” is specified based on an operation performed by the user, the management program acquires bookmark folder information included in each of the bookmark folders shown at the display position from the mail DB 62, the address book DB 63, the text memo DB 64, and/or the schedule DB 65. Then, the management program sets the bookmark names corresponding to the acquired bookmark folder information to list box elements for display, as illustrated in FIG. 3C, FIG. 3D, FIG. 3E, and FIG. 3F. Here, the style of displaying the bookmark names, which is illustrated in each of FIG. 3C, FIG. 3D, FIG. 3E, and FIG. 3F, agrees with the list which is set based on each of the corresponding application programs.

The details of each of the above-described mail-adaptable display processing (300), address book-adaptable display processing (400), text memo-adaptable display processing (500), and schedule-adaptable display processing (600) will be described later.

(Mail-Adaptable Display Processing)

Next, when the folder “mail” is specified based on an operation performed by the user in the state where the bookmark folders of the top hierarchy (the top of the hierarchy) illustrated in FIG. 3A had already been displayed, the URL information management program executes the mail-adaptable display processing (300) by performing the following steps.

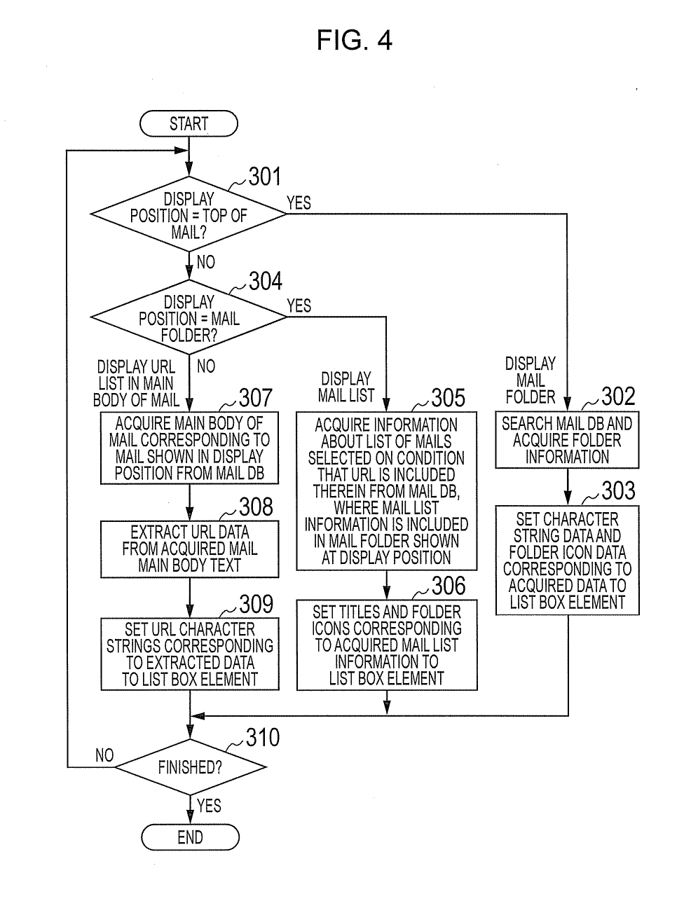

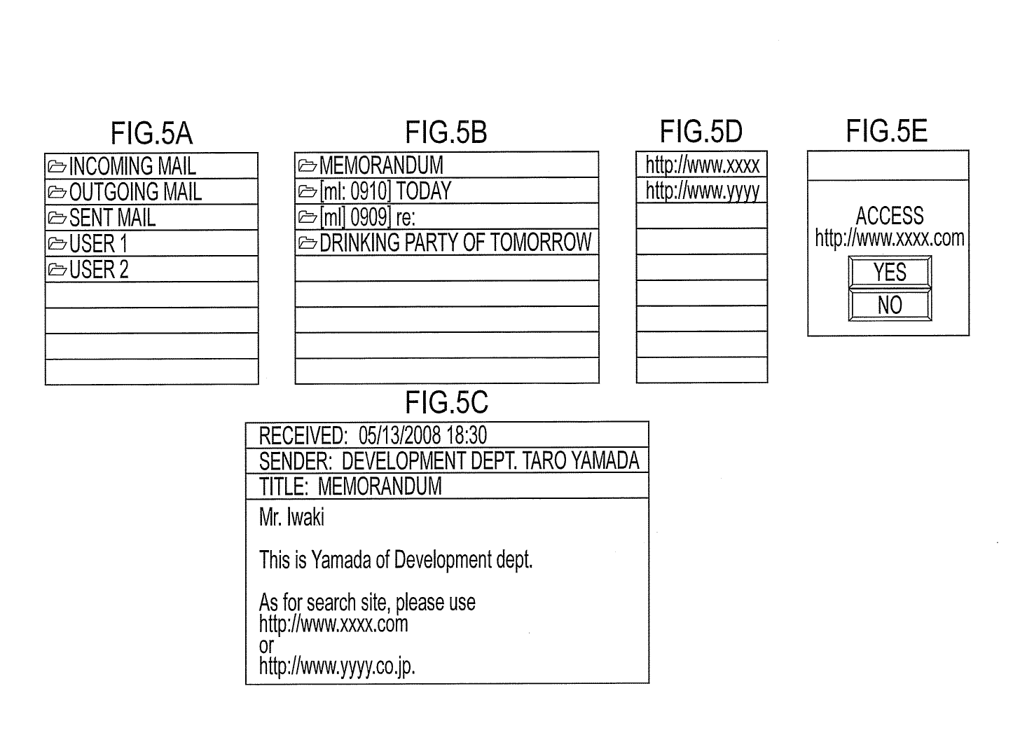

When the display position of the bookmark list (the display object state) is the mail top hierarchy illustrated in FIG. 5A (301 illustrated in FIG. 4) during the mail-adaptable display processing (300), the management program searches the mail DB 62 provided in the information storage function unit 6 and acquires folder information (302) to display the mail folders. Further, the management program sets the character strings and the folder icons corresponding to the acquired folder information (data) to the list box element in sequence (303), and determines whether or not the processing may be finished (310). The processing is continued unless the user operates the finish button provided on the mobile terminal MT.

As a result of the above-described processing performed to set the data to the list box element, the mail folder list is displayed as illustrated in FIG. 5A. Here, each of the folders “incoming mail”, “untransmitted mail”, “transmitted mail”, “user 1”, and “user 2” is displayed as a mail folder. Each of the folders “user 1” and “user 2” is generated by the user. Each of the above-described five folders is a virtual bookmark folder used to make the mail folder selection.

If the management program does not determine to finish the processing at step 310, the management program returns to make the determination corresponding to step 301. Further, when the display object state of the bookmark list does not correspond to the mail top hierarchy, namely, when the state where the mail folders had already been displayed is achieved as illustrated in FIG. 5A (304), mail list information included in a mail folder shown at the display position (the state where the mail folders had already been displayed) is acquired from the mail DB 62 (305) so as to display the list of electronic mails, where each of the electronic mails is selected on the condition that the main body thereof includes URL data. Further, the titles and folder icons corresponding to the acquired mail list information (data) are set to the list box element (306), and it is determined whether or not the processing may be finished (310).

In the state where the mail folders of the mail top hierarchy illustrated in FIG. 5A had already been displayed and the folder “incoming mail” is specified based on an operation performed by the user, the management program acquires mail list information included in the folder “incoming mail” which is a mail folder shown at the display position from the mail DB 62. Then, the management program sets data items “memorandum”, “drinking party of tomorrow”, and so forth provided as the bookmark names corresponding to the acquired mail list information to the list box element for display. Here, even though the titles such as incoming mails are displayed on the mail list, different data items may be selected for display based on an operation performed by the user.

If the management program does not determine to finish the processing at step 310, the management program returns to make the determination corresponding to step 301. Further, when the display position of the bookmark list does not correspond to the mail top hierarchy, namely, when the state where the mail folders had already been displayed is achieved as illustrated in FIG. 5A (304), text data of the main body of the electronic mail corresponding to an electronic mail shown at the display position is acquired from the mail DB 62 (307) so as to display the list of URLs shown in the main body of the electronic mail, and the URL data is extracted from the acquired mail main body text data (308). Further, the management program sets the URL character strings corresponding to the extracted URL data to the list box element in sequence for display (309).

Here, a known technology may be used for a URL extraction method performed to extract the URL data from the mail-main body text data. When target content data is text data, the management program determines “http://” and/or “https://” to be a head token and detects data of a character string that matches with the head token as the URL data. Further, when the target content data is generated under the hyper text markup language (HTML) system, the management program detects an anchor which becomes an http scheme and/or an https scheme, where “<Ahref=>” and/or “<form>” is determined to be the head character string. The above-described URL extraction method may also be used for the text memo-adaptable display processing (500) and the schedule-adaptable display processing (600) except the address book-adaptable display processing (400) which will be described later.

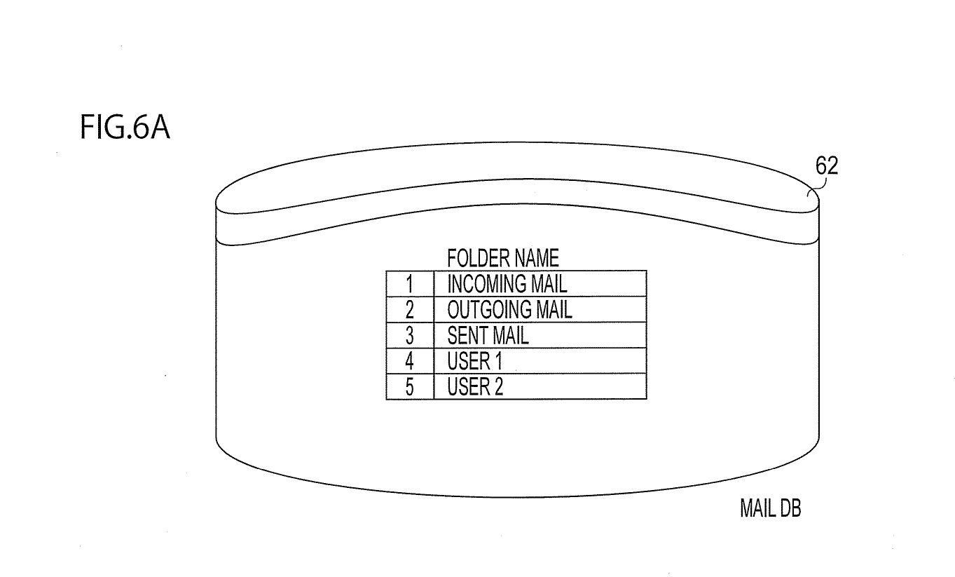

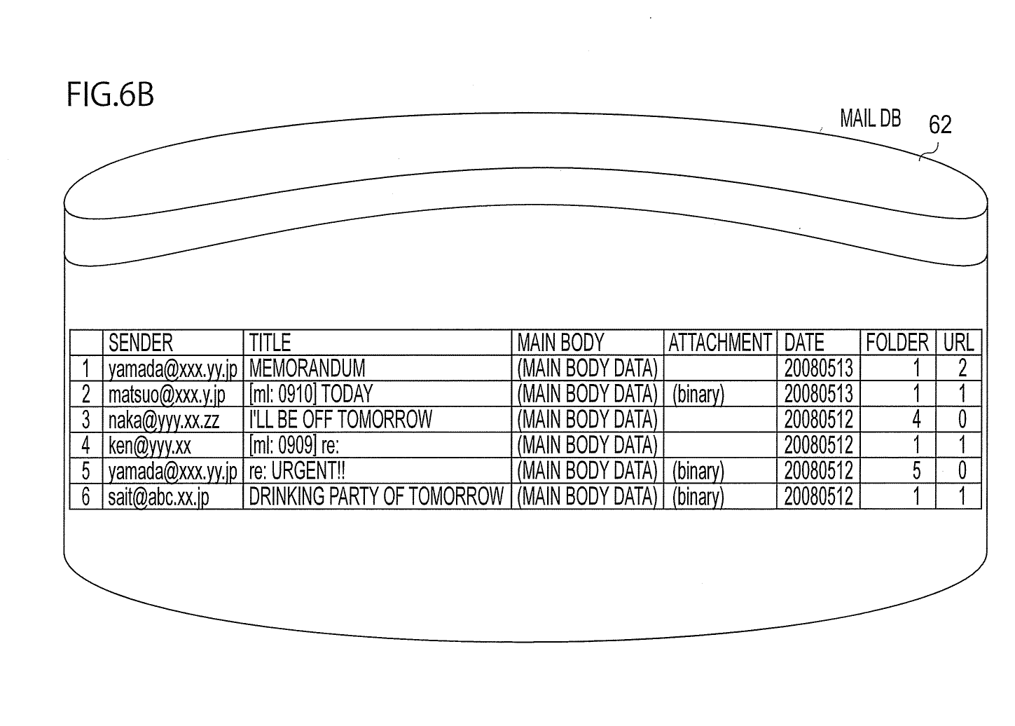

Here, if the title “memorandum” of the list box element is specified based on an operation performed by the user, for example, the mail-main body text data relating to the mail corresponding to the title “memorandum” is acquired from the mail DB 62 illustrated in FIG. 6A and FIG. 6B, and the URL data is extracted from the acquired mail-main body text data. As illustrated in FIG. 5C, the above-described mail-main body text data includes two URL data items that are shown as “http://www.xxxx.com” and “http://www.yyyy.co.jp”. Therefore, the URL character strings corresponding to the two URL data items are displayed on the list box element as illustrated in FIG. 5D.

Either of the two URL character strings that are displayed on the list box element is specified based on an operation performed by the user, the management program performs access confirmation display for the user, as illustrated in FIG. 5E based on the specified URL data. When the user specifies affirmation expressed as “YES” through the above-described display, a web browser is started for a target URL. The web browser connects the mobile terminal MT to a web site adaptable to the above-described target URL.

FIG. 6A and FIG. 6B illustrate an exemplary configuration of the mail DB 62 that is generated through a mail application program installed on the mobile terminal MT and that is stored in the information storage function unit 6 in advance. The mail DB 62 generated through the mail application program stores data of each of the sender (the address and/or the name), the title, the main body, an attached file, the date and time, and the folder name of each electronic mail. Here, data items of the names of the folders “incoming mail”, “untransmitted mail”, “transmitted mail”, “user 1”, and “user 2” that are provided as the mail folders are designated by the corresponding numerals 1 to 5 and stored.

Data of the field “URL” is added to the mail DB 62. Data of the number of URL data items that are included in the mail-main body text data except the mail header is stored in the field “URL” through the mail application program for each electronic mail. When the number indicating the number of the URL data item(s) is “0”, it means that no URL data is included in the mail-main body text data. In that case, the electronic mail is not displayed on the mail list illustrated in FIG. 5B.

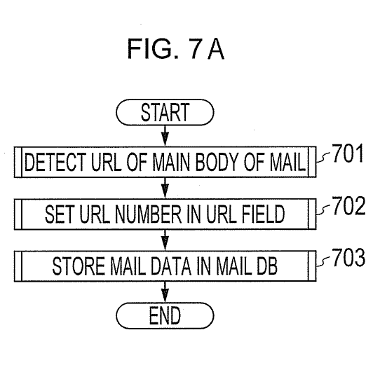

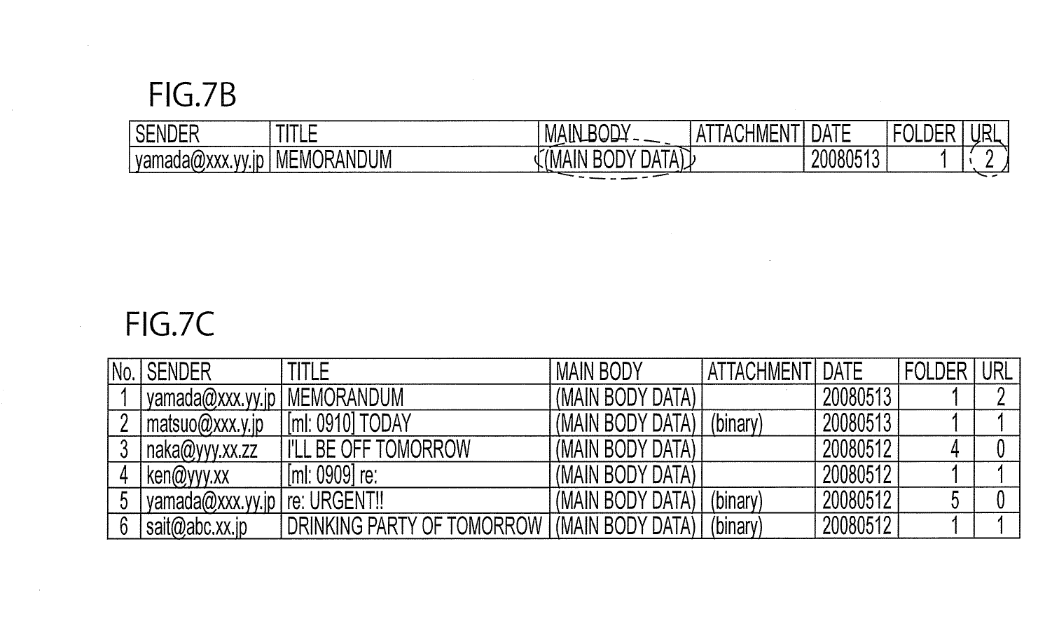

When storing mail data including data of the field “URL” in the mail DB 62, the mail application program detects URL data items that are included in the main body of target mail data (701 illustrated in FIG. 7A, FIG. 7B, and FIG. 7C) and the number of the detected URL data items is set to the field “URL” as the number of the URL data items (702). Then, the mail application program overwrites the mail DB 62 with the target mail data (703). Consequently, the mail application program can perform flag control in the field “URL” so as to perceive whether or not the URL data is included in the main body of each electronic mail while reducing an increase in the capacity of the mail DB 62.

The above-described flag control performed in the field “URL” so as to perceive whether or not the URL data is included in target content data can also be performed for the text memo-adaptable display processing (500) and the schedule-adaptable display processing (600) except the address book-adaptable display processing (400) which will be described later.

(Address Book-Adaptable Display Processing)

Next, when the folder “address book” is specified based on an operation performed by the user in the state where the bookmark folders of the top hierarchy (the top of the hierarchy) illustrated in FIG. 3A had already been displayed, the URL information management program executes the address book-adaptable display processing (400) by performing the following steps.

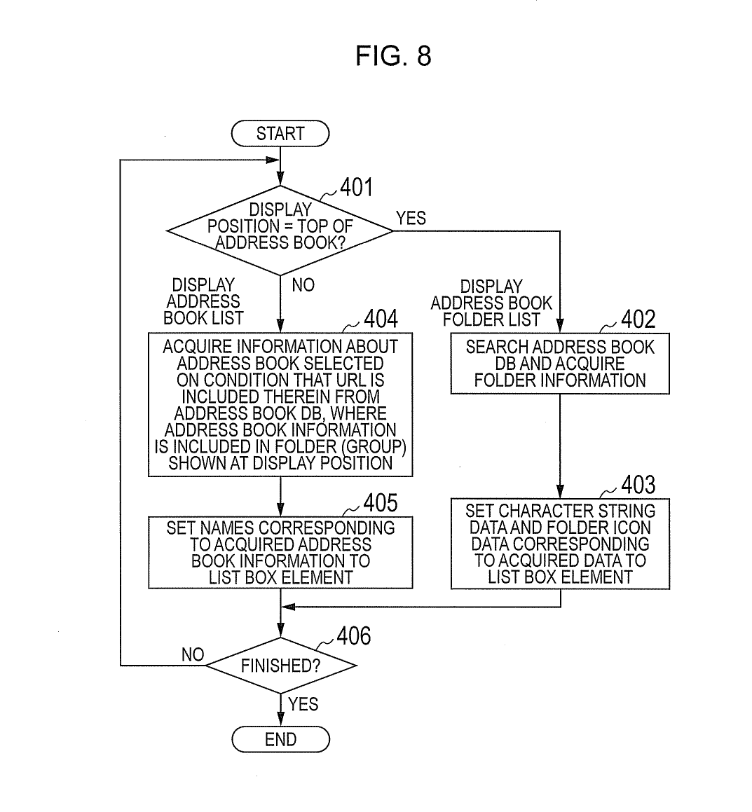

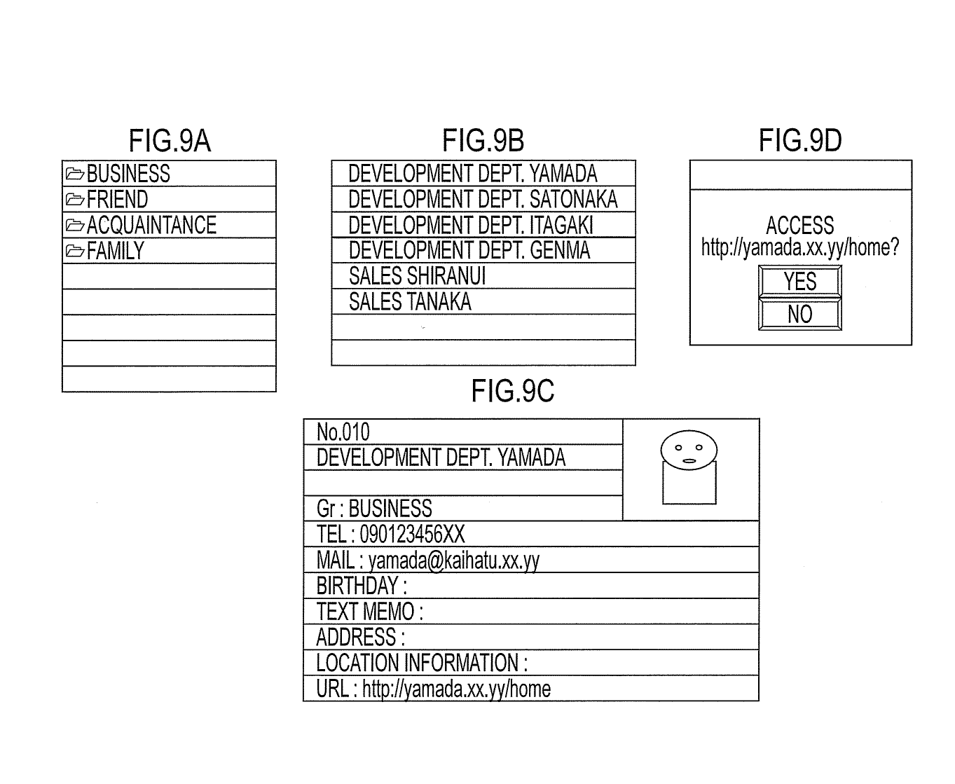

When the display position of the bookmark list (the display object state) is the address book top hierarchy illustrated in FIG. 9A (401 illustrated in FIG. 8) during the address book-adaptable display processing (400), the management program searches the address book DB 63 provided in the information storage function unit 6 and acquires folder information (402) to display the address book folder. Further, the management program sets the character strings and the folder icons corresponding to the acquired folder information (data) to the list box element in sequence (403), and determines whether or not the processing may be finished (406). The processing is continued unless the user operates the finish button provided on the mobile terminal MT.

As a result of the above-described processing performed to set the data to the list box element, the address book folder list is displayed as illustrated in FIG. 9A. Here, each of folders “business”, “friend”, “acquaintance”, and “family” is displayed as the address book folder. Each of the above-described four folders is a virtual bookmark folder used to select the address book folder.

If the management program does not determine to finish the processing at step 406, the management program returns to make the determination corresponding to step 401. Further, when the display object state of the bookmark list does not correspond to the address book top hierarchy, namely, when the state where the address book folders had already been displayed is achieved as illustrated in FIG. 9A (401), address book information (address book list information) included in an address book folder shown at the display position (the state where the address book folders had already been displayed) is acquired from the address book DB 63 (404) so as to display the list of address book data items, where each of the address book data items is selected on the condition that the address book data item includes URL data. Further, the names corresponding to the acquired address book list information (data) are set to the list box element (405), and it is determined whether or not the processing may be finished (406).

For example, in the state where address book folders of the address book top hierarchy illustrated in FIG. 9A had already been displayed and the folder “business” is specified based on an operation performed by the user, the management program acquires address book list information included in the folder “business” which is an address book folder shown at the display position from the address book DB 63. Then, the management program sets name data items “Development dept. Yamada”, “Development dept. Satonaka”, and so forth provided as the bookmark names corresponding to the acquired address book list information to the list box element, as illustrated in FIG. 9B. Here, even though only the names of address book list information items are displayed on the address book list, different data items may be selected for display based on an operation performed by the user.

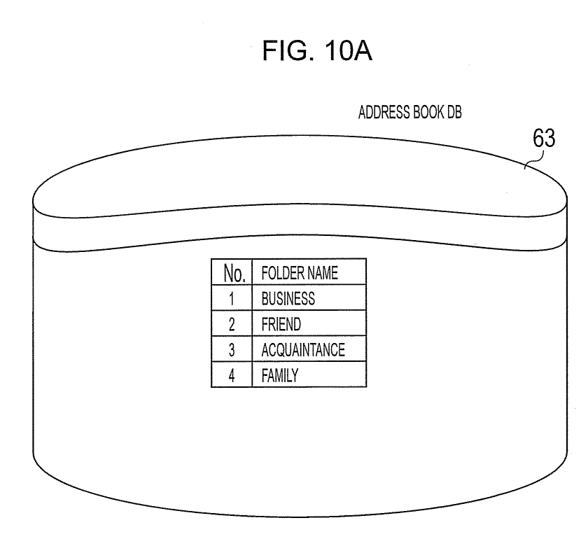

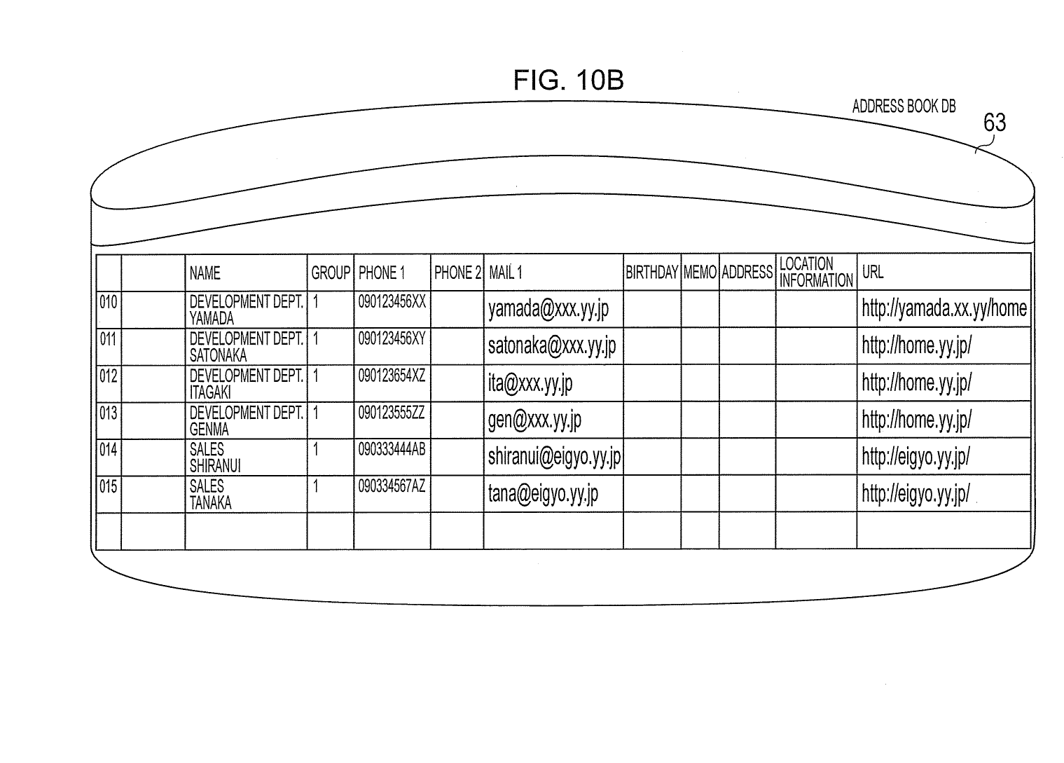

When the address book list is displayed and the name “Development dept. Yamada” of the list box element is specified based on an operation performed by the user, the management program acquires data of the details of the address book corresponding to the name “Development dept. Yamada” from the address book DB 63 illustrated in FIG. 10A and FIG. 10B, and extracts URL data from the acquired data of the details of the address book. As exemplarily illustrated in FIG. 9C, the detail data of the address book includes data of the URL “http://yamada.xx.yy/home”.

The management program performs access confirmation display for the user, as illustrated in FIG. 9D based on the extracted URL data. When the user specifies affirmation expressed as “YES” through the above-described display, a web browser is started for a target URL. The web browser connects the mobile terminal MT to a web site adaptable to the above-described target URL.

FIG. 10A and FIG. 10B illustrate an exemplary configuration of the address book DB 63 that is generated through an address book application program installed on the mobile terminal MT and that is stored in the information storage function unit 6 in advance. The address book DB 63 generated through the address book application program stores data of each of a name, the group number, a phone number, and an electronic mail address, and so forth for each address book information item. Here, data items of the names of the folders “business”, “friend”, “acquaintance”, and “family” that are provided as the address book folders are designated by numerals 1 to 4 that indicate groups and stored.

Data of the field “URL” is added to the address book DB 63. Data of a URL generated through the address book application program based on data transmitted from the user is stored for each address book information item. In the above-described embodiment, a URL generated for the name “Development dept. Yamada” shown in the address book information is “http://yamada.xx.yy/home”. Further, a URL generated for the names “Development dept. Satonaka”, “Development dept. Itagaki”, and “Development dept. Genma” is “http://home.yy.jp/”. Further, a URL generated for the names “Sales Shiranui” and “Sales Tanaka” is “http://eigyo.yy.jp/”.

(Text Memo-Adaptable Display Processing)

Next, when the folder “text memo” is specified based on an operation performed by the user in the state where the bookmark folders of the top hierarchy (the top of the hierarchy) illustrated in FIG. 3A had already been displayed, the URL information management program executes the text memo-adaptable display processing (500) by performing the following steps.

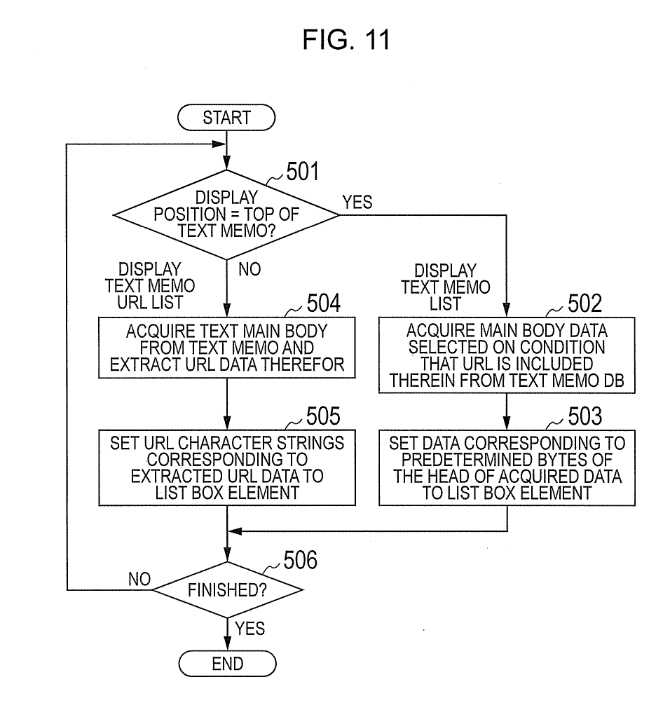

When the display position of the bookmark list (the display object state) is the text memo top hierarchy illustrated in FIG. 3E (501 illustrated in FIG. 11) during the text memo-adaptable display processing (500), the management program searches the text memo DB 64 provided in the information storage function unit 6 and acquires text memo-main body data selected on the condition that URL data is included in the text memo-main body data (502) to display the text memo list. Further, the management program sets the character strings corresponding to predetermined bytes of the head of the acquired text memo-main body data, that is, the length of a displayed list box to the list box element (503), and determines whether or not the processing may be finished (506). The processing is continued unless the user operates the finish button provided on the mobile terminal MT.

As a result of the above-described processing performed to set the data to the list box element, the text memo list (folders) is displayed as illustrated in FIG. 3E. Here, the folders “place of drinking party”, “memorandum”, “memorandum part 2”, “memorandum part 3”, and “today's memo” are displayed as the text memo list. Each of the above-described five folders is a virtual bookmark folder used to select the text memo folder illustrated in FIG. 3A.

If the management program does not determine to finish the processing at step 506, the management program returns to make the determination corresponding to step 501. Further, when the display object state of the bookmark list does not correspond to the text memo top hierarchy, namely, when the state where the folders of the text memo list had already been displayed is achieved as illustrated in FIG. 3E (501), the main body data corresponding to text memo data shown at the display position is acquired from the text memo DB 64 so as to display the list of URL data items included in the text memo-main body data, and URL data is extracted from the acquired text memo-main body data (504). Further, the management program sets the URL character strings corresponding to the extracted URL data to the list box element in sequence (505).

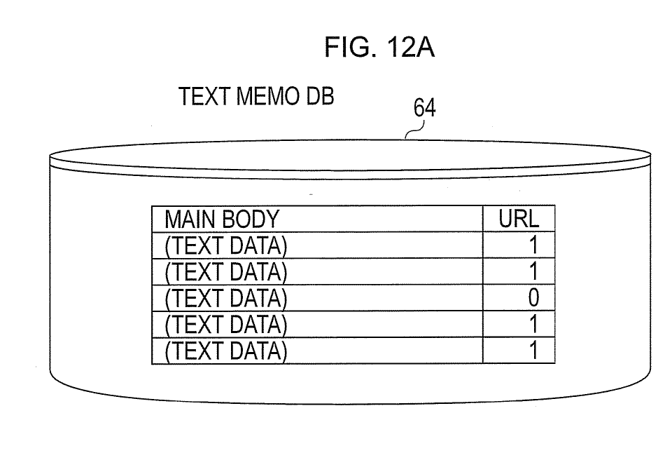

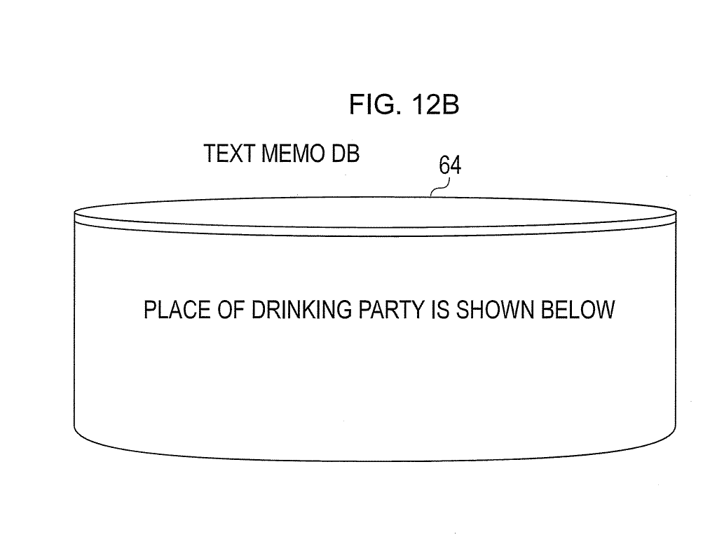

When the data “place of drinking party” of the list box element is specified based on an operation performed by the user, text memo-main body data relating to the text memo corresponding to the data “place of drinking party” is acquired from the text memo DB 64 illustrated in FIG. 12A and FIG. 12B, and URL data is extracted from the acquired text memo-main body data. As exemplarily illustrated in FIG. 12A and FIG. 12B, the text memo-main body data includes data of a single URL shown as “http://www.restaurant_x.xx”. Therefore, the URL character string corresponding to the URL data is displayed on the list box element, as is the case with FIG. 5D.

When the URL character string displayed on the list box element is specified based on an operation performed by the user, the management program performs the same access confirmation display as that illustrated in FIG. 5E for the user. When the user specifies affirmation expressed as “YES” through the above-described display, a web browser is started for a target URL. The web browser connects the mobile terminal MT to a web site adaptable to the above-described target URL.

When a single URL data item is included in the text memo-main body data, a URL character string may not be displayed on the list box element, as is the case with the above-described address book-adaptable display processing (400). In that case, the management program only performs the access confirmation display for the user so as to connect the mobile terminal MT to a web site adaptable to the URL.

FIG. 12A and FIG. 12B illustrate an exemplary configuration of the text memo DB 64 that is generated through a text memo application program installed on the mobile terminal MT and that is stored in the information storage function unit 6 in advance. The text memo DB 64 generated through the text memo application program stores data of the main body (text data) for each text memo.

Data of the field “URL” is added to the text memo DB 64. Data of the number of URL data items that are included in the main body data is stored in the field “URL” through the text memo application program for each text memo data item. When the number indicating the number of the URL data item(s) is “0”, it means that no URL data is included in the text memo-main body data. In that case, the text memo is not displayed on the text memo list illustrated in FIG. 3E.

(Schedule-Adaptable Display Processing)

Next, when the folder “schedule” is specified based on an operation performed by the user in the state where the bookmark folders of the top hierarchy (the top of the hierarchy) illustrated in FIG. 3A had already been displayed, the URL information management program executes the schedule-adaptable display processing (600) by performing the following steps.

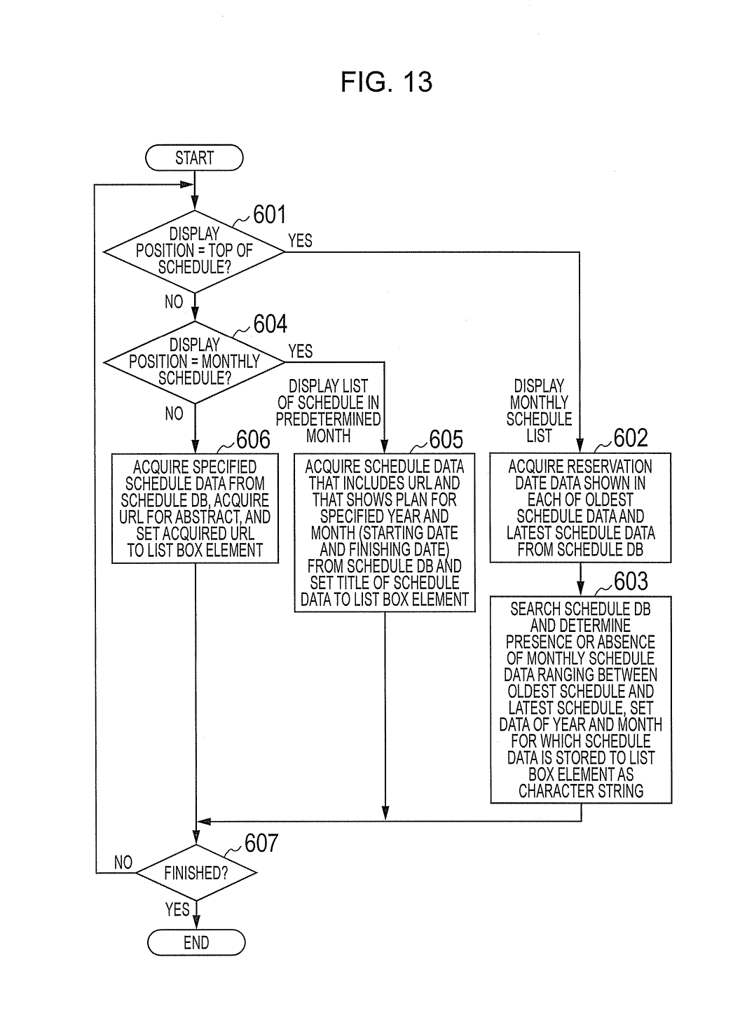

When the display position of the bookmark list (the display object state) is the schedule top hierarchy illustrated in FIG. 3F (601 illustrated in FIG. 13) during the schedule-adaptable display processing (600), the management program searches the schedule DB 65 provided in the information storage function unit 6 and acquires information about the planned date and time of each of the oldest schedule data and the latest schedule data (602) so as to display the monthly schedule list. Further, the management program searches the schedule DB 65 and calculates the presence or absence of monthly schedule data ranging between the oldest schedule data and the latest schedule data (603). Then, data of the year and the month for which the schedule data is provided is set to the list box element as character string data (603), and it is determined whether or not the processing may be finished (607). The processing is continued until the user operates the finish button provided on the mobile terminal MT.

As a result of the above-described processing performed to set the data to the list box element, the monthly schedule list (folders) is displayed as illustrated in FIG. 3F. Here, the folders “2008/7”, “2008/6”, “2008/5”, “2008/4”, “2008/3”, “2008/2”, and “2008/1” are displayed as the monthly schedule list. Each of the above-described seven folders is a virtual bookmark folder used to select the schedule folder illustrated in FIG. 3A.

When the management program does not determine to finish the processing at step 607, the management program returns to make the determination corresponding to step 601. Further, when the display object state of the bookmark list does not correspond to the schedule top hierarchy, namely, when the state where the folders of the monthly schedule list had already been displayed is achieved as illustrated in FIG. 3F (601), schedule data that includes URL data and that shows a plan for specified year and month, where the starting day and time and the finishing day and time overlap one another, is acquired from the schedule DB 65 so as to display the daily schedule list of a predetermined month. After that, the management program sets data of the title of the acquired schedule data (for example, “monthly meeting July”) to the list box element, and determines whether or not the processing may be finished (607).

When the management program does not determine to finish the processing at step 607, the management program returns to make the determination corresponding to step 601. Further, when the display position is not the schedule top hierarchy (601) and is not the monthly schedule list (604), the management program acquires schedule data specified by the user from the schedule DB 65 (606). Still further, the management program extracts the URL data from an abstract of the acquired schedule data, and sets the extracted URL data to the list box element (606).

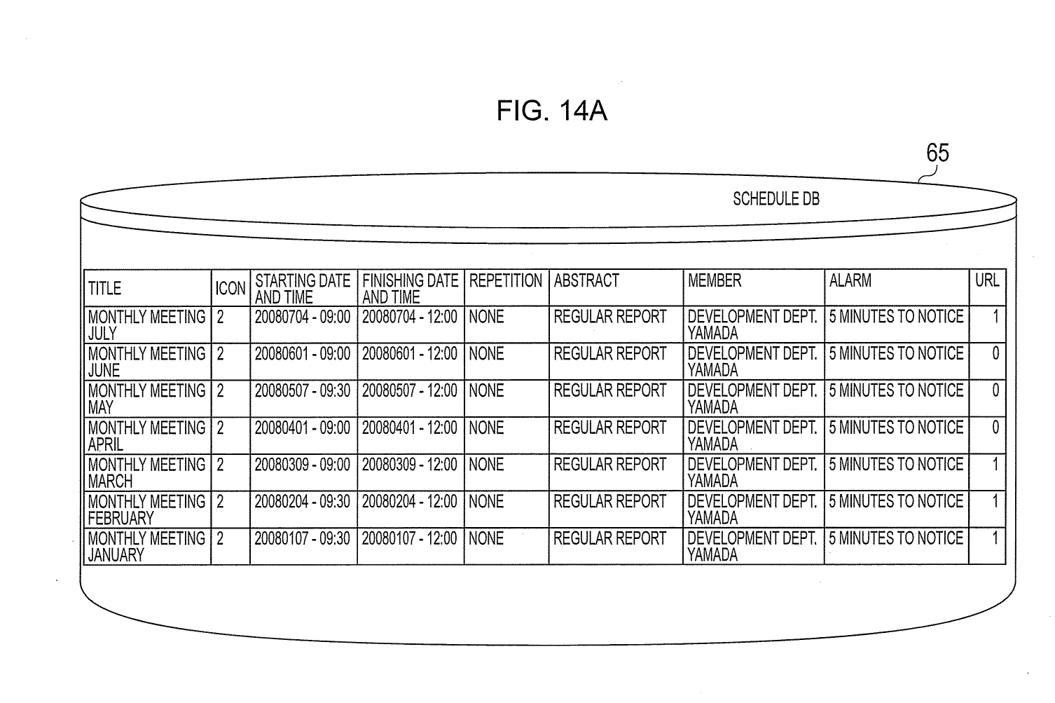

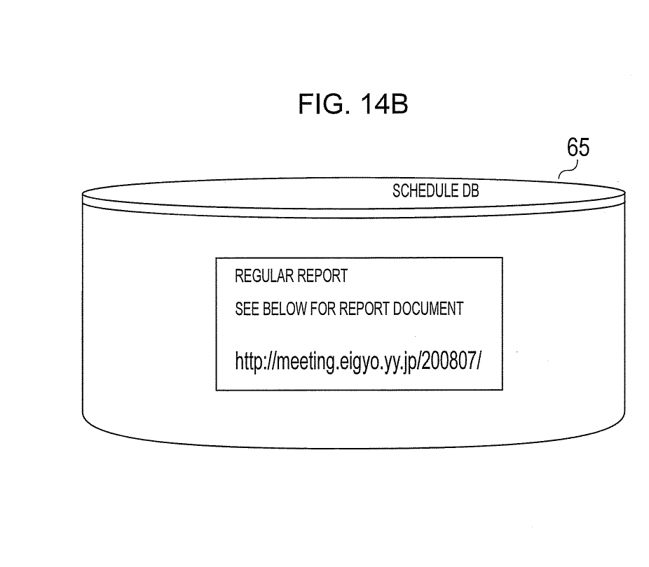

Here, when the title data shown as “monthly meeting July” of the list box element is specified based on an operation performed by the user, abstract data (text data) of the schedule corresponding to the title data “monthly meeting July” is acquired from the schedule DB 65 illustrated in FIG. 14A and FIG. 14B, and the URL data is extracted from the acquired text data of the abstract data. As exemplarily illustrated in FIG. 14A and FIG. 14B, the abstract data includes a single URL data item shown as “http://meeting.eigyo.yy.jp/200807/”. Therefore, the URL character string data corresponding to the URL data is displayed on the list box element as is the case with FIG. 5D.

When the URL character string data displayed on the list box element is specified based on an operation performed by the user, the management program performs the same access confirmation display as that illustrated in FIG. 5E for the user. When the user specifies affirmation expressed as “YES” through the above-described display, a web browser is started for a target URL. The web browser connects the mobile terminal MT to a web site adaptable to the above-described target URL.

When a single URL data item is included in the text data of the abstract data, a URL character string may not be displayed on the list box element, as is the case with the above-described address book-adaptable display processing (400). In that case, the management program only performs the access confirmation display for the user so as to connect the mobile terminal MT to a web site adaptable to the URL.

FIG. 14A and FIG. 14B illustrate an exemplary configuration of the schedule DB 65 that is generated through a schedule application program installed on the mobile terminal MT and that is stored in the information storage function unit 6 in advance. The schedule DB 65 generated through the schedule application program stores abstract data or the like for each schedule data item.

Data of the field “URL” is added to the schedule DB 65. Data of the number of URL data items that are included in the abstract data is stored in the field “URL” through the schedule application program for each schedule data item. When the number indicating the number of the URL data item(s) is “0”, it means that no URL data is included in the abstract data of the schedule data item. In that case, the schedule data item is not displayed on the daily schedule list of a predetermined month.

(URL Copying Function)

The URL information management program executing the above-described mail-adaptable display processing (300), address book-adaptable display processing (400), text memo-adaptable display processing (500), and schedule-adaptable display processing (600) can execute selective URL copying by performing the following steps according to the list of URL data items or the like in addition to starting the web browser.

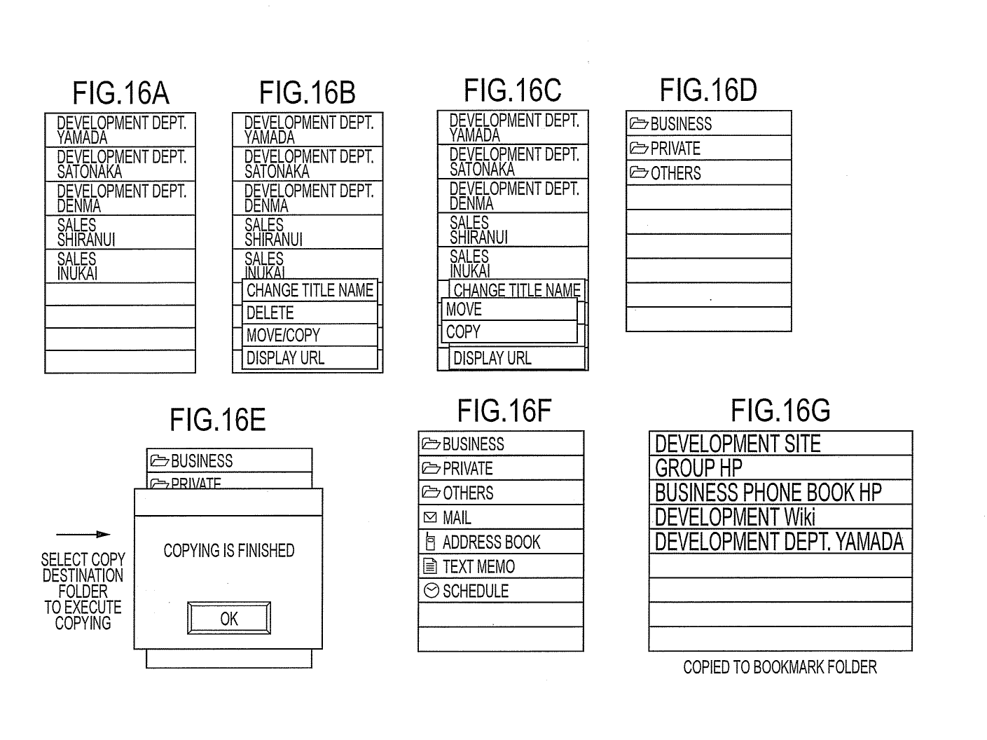

For example, when the user specifies the folder “Development Dept. Yamada”, and operates (presses) a menu key in the state where the address book list is displayed as illustrated in FIG. 16A during the address book-adaptable display processing (400), menu data is displayed. As illustrated in FIG. 16B, the menu data includes data shown as “move/copy”, data shown as “display URL”, and so forth.

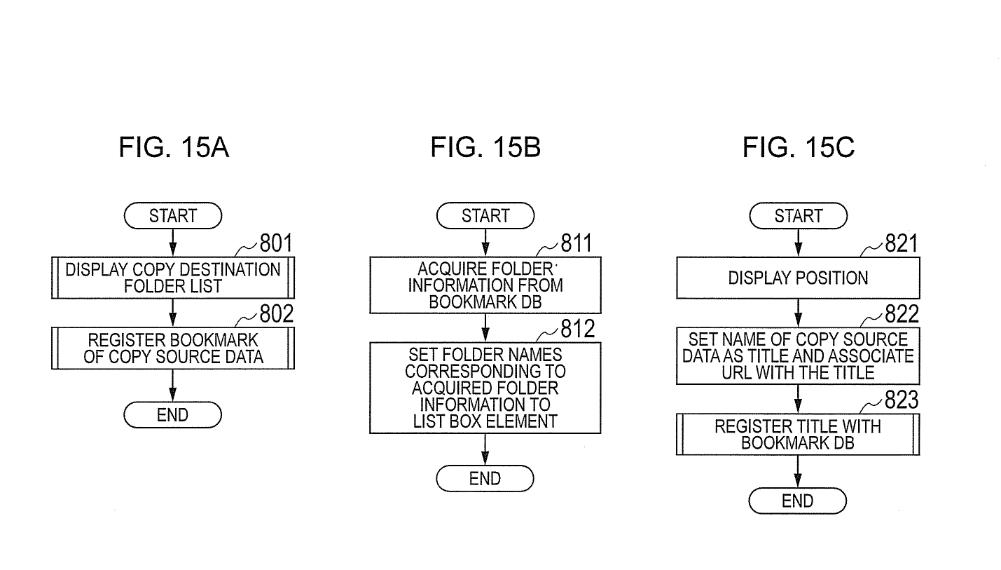

When the user selects the data “move/copy” from among the displayed menu data illustrated in FIG. 16B, data “move” and/or data “copy” of the menu data is displayed to the front for selection as illustrated in FIG. 16C. When the user selects the above-described data “copy”, the management program displays the list of copy destination folders only for the bookmark folders as illustrated in FIG. 16D (801 illustrated in FIG. 15A).

When the copy destination folder list is displayed and the user selects the folder “business” as the copy destination folder, the management program performs copying. After that, the management program displays a message indicating that the copying is finished and requests the user to confirm that the copying is finished as illustrated in FIG. 16E. When the user specifies a confirmation message displayed as “OK”, the URL copying processing is finished. Consequently, data of the details (the name and the URL data) of the folder “Development dept. Yamada” placed under the folder “business” shown in the address book data is additionally registered under the folder “business” of the bookmark as copy source data and bookmark data, as illustrated in FIG. 16F and FIG. 16G (802 illustrated in FIG. 15A).

More specifically, during the copy destination folder list display processing (801), the management program acquires the bookmark folder information from the bookmark DB 61 (811 illustrated in FIG. 15B), and sets the folder name data items “business”, “private”, and “others” corresponding to the acquired bookmark folder information to the list box element for display (812 illustrated in FIG. 15B).

Further, during the processing performed to register the bookmark of the above-described copy source data (802), the management program determines the details of the copy source data based on the display position (821 illustrated in FIG. 15C). In the above-described embodiment, the management program determines the copy source data to be the address book data, and sets the name data “Development dept. Yamada” included in the address book data to the list box element provided under the folder “business” of the bookmark, as title data. Further, the management program associates the URL data with the title data (822 illustrated in FIG. 15C). Then, the management program registers the title data “Development dept. Yamada” and the URL data “http://yamada.xx.yy/home” with the folder “business” of the bookmark DB 61 (823 illustrated in FIG. 15C).

Accordingly, the present invention provides a technology of allowing a user to easily and directly access URL information other than bookmark data managed by a web browser through a bookmark function. The disclosed mobile terminal allows a user to use content data different from bookmark data managed through the bookmark function as virtual bookmark data.

The above-described processing performed according to an embodiment may be provided as a program that can be executed through a computer. Further, the above-described processing may be provided via a recording medium including a CD-ROM, a flexible disk, and so forth, or a communication line.

All or an arbitrary number of the above-described processing procedures performed according to an embodiment may be selected and combined for execution.

Appendixes are disclosed as below in relation to the above-described embodiment and modifications.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present inventions have been described in detail, it should be understood that the various changes, substitutions, and alterations could be made hereto without departing from the spirit and scope of the invention.

What is claimed is:

1. An apparatus for operating first and second application functions, the apparatus being capable of connecting to a plurality of sites via a network, the apparatus comprising:
a display device for displaying contents information by the first and second application functions;
a memory for storing address information of any of the sites to be used by the first application function and contents information including title information and associated contents data to be used by the second application function independently from the first application function; and
a processor for executing a process including:
controlling operation of the first and second application functions independently;
displaying a bookmark list including the address information on the display device in response to a user's operation, accessing one of the sites when address information corresponding to the one of the sites displayed on the bookmark list is selected by the user, and displaying contents information retrieved from the one of the sites by the first application function; and
enabling any of the title information to be added to the bookmark list by a user operation, extracting, when the title information added to the bookmark list is displayed and selected by the user, any portion of the contents data included in the contents information corresponding to the title information selected by the user, and displaying the extracted portion of the content data.

2. The apparatus according to claim 1, wherein the portion is address information included in the contents data selected.

3. The apparatus according to claim 1, wherein the first application is a browser.

4. The apparatus according to claim 1, wherein the second application is an application of e-mailing.

5. The apparatus according to claim 1, wherein the contents information is mail data, address book data, text memo data, and schedule data.

6. The apparatus according to claim 1, wherein the memory stores the number of the address information included in the contents information.

7. The apparatus according to claim 1, wherein the bookmark list has hierarchy.

8. The apparatus according to claim 7, wherein the process further displays the title information of the on the basis of the predetermined hierarchy information of the bookmark list.

9. A method for controlling an apparatus including a display device, a memory, and a processor for operating first and second application functions, the apparatus being capable of connecting to a plurality of sites via a network, the method comprising:
displaying contents information by the first and second application functions to the display device;
storing address information of any of the sites to be used by the first application function and contents information including title information and associated contents data to be used by the second application function independently from the first application function to the memory;
controlling operation of the first and second application functions independently by the processor;
displaying a bookmark list including the address information on the display device in response to a user's operation, accessing one of the sites when address information corresponding to the one of the sites displayed on the bookmark list is selected by the user, and displaying contents information retrieved from the one of the sites by the first application function by the processor; and
enabling any of the title information to be added to the bookmark list by a user operation, extracting, when the title information added to the bookmark list is displayed and selected by the user, any portion of the contents data included in the contents information corresponding to the title information selected by the user, and displaying the extracted portion of the content data by the processor.
